(19) United States
(12) Patent Application Publication
(10) Pub. No.: US 2005/0217088 A1
(43) Pub. Date: Oct. 6, 2005

(54) Secure device

(76) Inventor: Chiang Chun Lin, Lu Chou City (TW)

Correspondence Address: MORTON J ROSENBERG ESQ;ROSENBERG KLEIN & LEE, 3458 ELLICOTT CENTER DRIVE, SUITE 101, ELLICOTT, MD, 21043, US

(21) Appl. No.: 10/816,866

(22) Filed: Apr. 5, 2004

(51) Int. Cl. F16B 13/00

(52) U.S. Cl. 24/458

(57) ABSTRACT

A secure device has a base having an orientation plate and two side plates respectively connecting two lateral sides of the orientation plate, a neck portion having two first half bodies and a first cut slot formed therebetween, and a guiding-in portion having two second half bodies and a second cut slot formed therebetween. The two first half bodies have first lower ends thereof connecting the base, the two second half bodies include second lower ends thereof connecting the neck portion, and the second cut slot communicates with the first cut slot of the neck portion. The guiding-in portion has a lower exterior diameter longer than an upper exterior diameter of the neck portion for the neck portion being comparatively shrunk with the guiding-in portion. Therefore, the secure device can mount or secure an electronic component to a circuit board, or provides two objects connecting to each other.

### BACKGROUND OF THE INVENTION

1. Field of the Invention

The present invention relates to a secure device, and particularly relates to a secure device adopted for electrical components, such as heat sinks, connecting to a circuit board, or for combining two objects together.

2. Background of the Invention

Nowadays, chips such as, for example, a micro central processing unit or a memory, must include heat sinks to dissipate redundant heat and lengthen the lives thereof. The heat sinks usually firmly connect to the chips of a circuit board via a proper secure device.

Referring to FIG. 1, a conventional heat sink 90 is secured to a chip 93 of a circuit board 92 by a plurality of buckling members 91 thereof. FIG. 1a shows the buckling member 91 assembled in advance into a corresponding through hole 94 of the heat sink 90. The buckling member 91 includes a head portion 95 arranged on an upper end thereof and a hook portion 96 disposed on a lower end thereof. A spring 97 is sleeved on the buckling member 91, and the buckling member 91 can be assembled into a corresponding buckling hole 98 on the circuit-board 92 via the corresponding through hole 94. The hook portion 96 of the buckling member 91 is shaped as a barb for retention against a bottom surface of the circuit board to prevent the buckling member 91 from separating from the corresponding buckling hole 98. The heat sink 90 connects the circuit board 92 firmly. The spring 97 presses the heat sink 90 onto the chip 93 for dissipating heat therefrom, and the chip 93 can prevent size variation due to thermal expansion at hot temperatures and avoid damage.

The prior art mentioned above provides four buckling members 91 adopted for assembly of the heat sink 90 on the circuit board 92. During the assembling step, the buckling members 91 are manually assembled, one by one, and respectively penetrate through the through hole 94 of the heat sink 90 and the buckling hole 98 of the circuit board 92. This may require much time and waste much labor. Furthermore, the buckling member 91 is pushed into the through hole 94 and the buckling hole 98, and the hook portion 96 of the buckling member 91 consequently deforms. Thus, the buckling member 91 engages obliquely when the hook portion 96 is retained against the bottom surface of the circuit board 92, the heat sink 90 is disposed obliquely thereby, and the heat sink 90 contacts the chip 93 imperfectly to reduce the heat dissipation efficiency.

The prior art mentioned above only provides the heat sink 90 secured to the chip 93. With respect to FIG. 2, a conventional housing 100 includes an upper casing 101 and a lower casing 102 assembled to each other, and requires a plurality of screws 103 penetrating through the upper casing 101 to connect to screwed posts 104 of the lower casing 102, respectively. The screws 103 are the secure devices that connect the upper casing 101 and the lower casing 102 together to be the housing 100.

Hence, an improvement over the prior art is required to overcome the disadvantages thereof.

### SUMMARY OF INVENTION

The primary object of the invention is therefore to specify a secure device, which can be placed on a circuit board via a mechanical manipulator for automatic processing, large quantity manufacturing to reduce failure rate, improve efficiency and increase economic benefits.

The secondary object of the invention is therefore to specify a secure device that can be mounted on a circuit board firmly and perfectly; accordingly, electronic products, such as heat sinks, can contact surfaces of chips tightly to increase heat dissipation efficiency.

The third object of the invention is therefore to specify a secure device adopted for connecting two objects (for example, an upper casing and a lower casing) together for another purpose.

According to the invention, this primary object is achieved by a secure device including a base having an orientation plate and two side plates respectively connecting two lateral sides of the orientation plate, a neck portion having two first half bodies and a first cut slot formed therebetween, and a guiding-in portion having two second half bodies and a second cut slot formed therebetween. The two first half bodies include first lower ends thereof connecting the base, the two second half bodies include second lower ends thereof connecting the neck portion, and the second cut slot communicates with the first cut slot of the neck portion. The guiding-in portion includes a lower exterior diameter longer that an upper exterior diameter of the neck portion for the neck portion being comparatively shrunk with the guiding-in portion.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a decomposition view of a conventional secure device;

FIG. 1a is an enlarged cross-sectional profile of the conventional secure device;

FIG. 2 is a an enlarged cross-sectional profile of another conventional secure device;

FIG. 3 is a perspective view of a first embodiment according to the present invention;

FIG. 4 is a front view of the first embodiment according to the present invention;

FIG. 5 is a side view of the first embodiment according to the present invention;

FIG. 6 is perspective view of the first embodiment while in use;

FIG. 7 is a perspective view of a second embodiment according to the present invention;

FIG. 8 is a front view of the second embodiment according to the present invention;

FIG. 9 is a side view of the second embodiment according to the present invention;

FIG. 10 is a perspective view of a third embodiment according to the present invention;

FIG. 11 is a front view of the third embodiment according to the present invention;

FIG. 12 is a side view of the third embodiment according to the present invention;

FIG. 13 is a decomposition view of a fourth embodiment according to the present invention;

FIG. 14 is a perspective view of the fourth embodiment according to the present invention;

FIG. 15 is a front view of the fourth embodiment according to the present invention;

FIG. 16 is a side view of the fourth embodiment according to the present invention;

FIG. 17 is a perspective view of a fifth embodiment while in use;

FIG. 18 is a perspective view of a sixth embodiment while in use;

FIG. 19 is a first perspective view of a seventh embodiment while in use; and

FIG. 20 is a second perspective view of the seventh embodiment while in use.

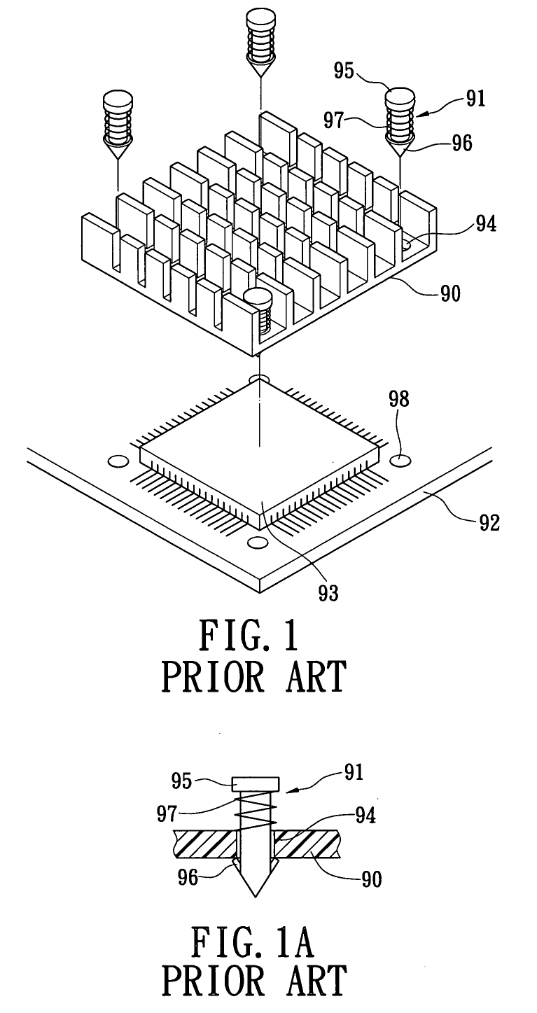

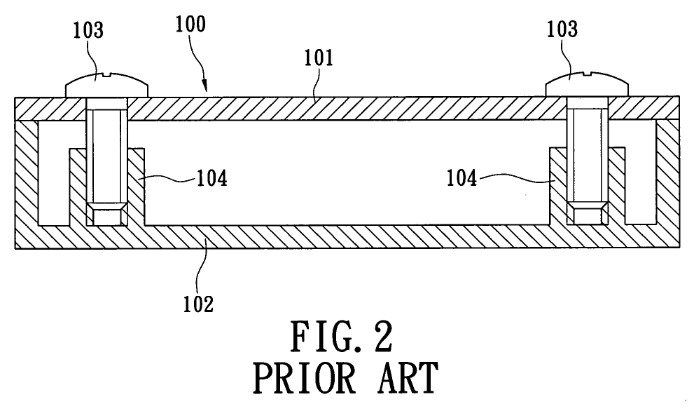

### DETAILED DESCRIPTION OF THE EMBODIMENTS

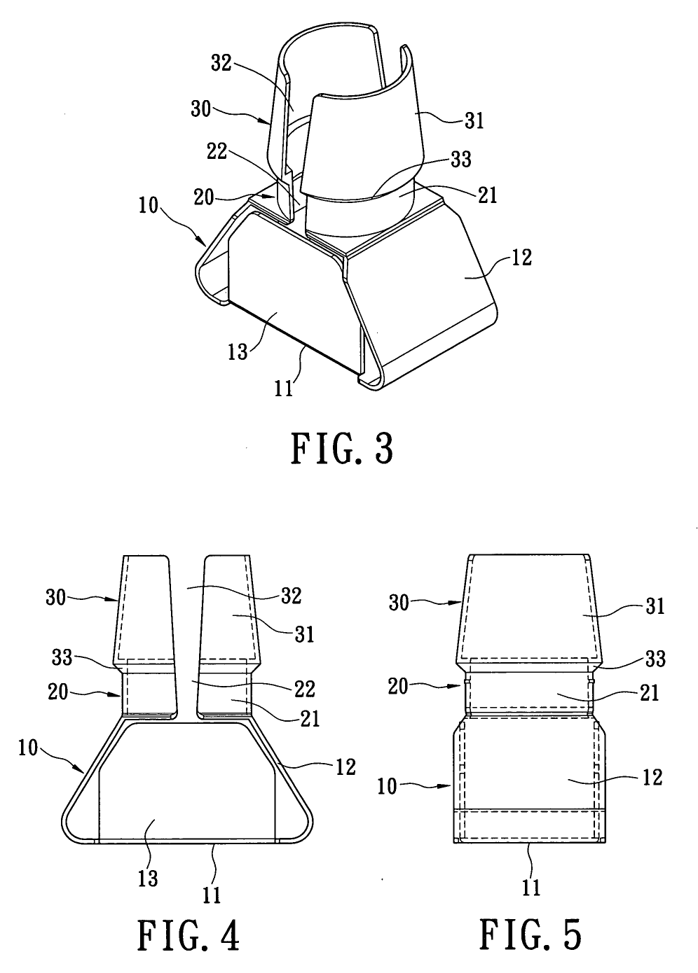

FIGS. 3 to 5 shows a secure device according to the present invention. According to the best embodiment, the secure device can connect the electronic product, such as heat sink, to a circuit board. The secure device is made integrally in one piece of resilient metallic material. The secure device includes a base 10, a neck portion 20 and a guide-in portion 30. The base 10 is bent, curved and shaped as a stair step, and includes an orientation plate 11 and two side plates 12 respectively connecting two lateral sides of the orientation plate 11. The orientation plate 11 is shaped as a plate and connects the circuit board or other object via a soldering process. The two side plates 12 of the base 10 are slanted towards each other, or are resilient. The orientation plate 11 of the base 10 has a height-retention wall 13 extending upwardly from each of front and rear sides thereof to be adjacent a top of the base 10. When the base 10 supports the neck potion 20, the height-retention wall 13 is retained against a bottom of the neck portion 20 to avoid the base 10 over-deforming.

The neck portion 20 includes two first half bodies 21 and a first cut slot 22 formed between the two half bodies 21 for separating the two first half bodies 21 from each other. Therefore, the neck portion 20 has an adjustable exterior diameter. The two first half bodies 21 includes first lower ends thereof connecting the base 10, and the two first half bodies 21 of the neck portion 20 are hollow, half-cylindrical and relative to each other.

The guide-in portion 30 includes two second half bodies 31 and a second cut slot 32 formed therebetween. The two second half bodies 31 of the guide-in portion 30 are hollow, half-conical and relative to each other, and include second lower ends thereof connecting the neck portion 20. The second cut slot 32 communicates with the first cut slot 22 of the neck portion 20. Therefore, the guiding-in portion 30 has an adjustable exterior diameter.

The guiding-in portion 30 includes a maximum exterior diameter formed on a lower end thereof longer that an upper exterior diameter of the neck portion 20 for the neck portion 20 being comparatively shrunk with the guiding-in portion 30. The secure device further includes an inclined face 33 formed between the neck portion and the guide-in portion for perfect contact with the heat sink or other objects.

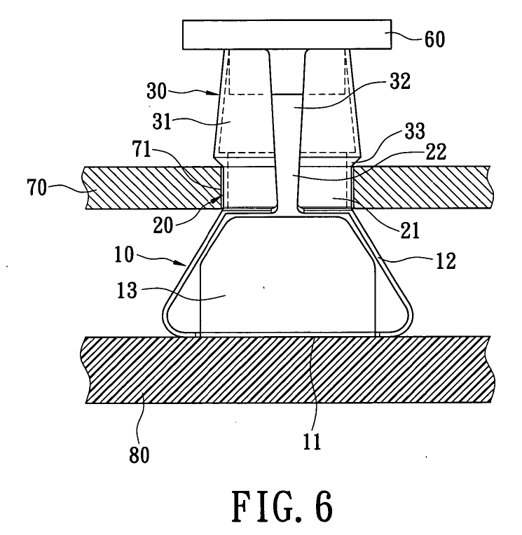

Referring to FIG. 6, the secure device can be mounted on a circuit board 80 for connecting an electronic product, such as heat sink, to the circuit board 80. The guide-in portion 30 of the secure device includes a stuff member 60 disposed therein. The stuff member 60 is made of rubber material that endures high temperature. The stuff member 60 is received in the guide-in portion 30 first to make the secure device solid. The stuff member 60 also can be made of other materials, and the stuff member 60 can be replaced by a cover or the like. The secure device is filled the stuff member 60 or the cover, thereby becoming solid, and then can be disposed on the circuit board 80 by a mechanical manipulator for surface mounting during the reflow process. The process can be automated for rapid manufacturing, and the present secure device is particularly adopted for quantity fabrication without manual labor to reduce product failure rates and increase economic benefits.

The guide-in portion 30 guides a through hole 71 of the electronic product 70 for sleeved on the neck portion 20 of the secure device. The guide-in portion 30 exposes out of the electronic product 70, and the inclined face 33 is retained against the electronic product 70 to firmly secure the electronic product 70 on the circuit board 80.

The secure device connects to circuit board 80 by the orientation plate 11 by soldering. Therefore, the secure device does not provide a hook engaging with the circuit board 80, and the orientation plate 11 of the base 10 is firmly and perfectly soldered onto the circuit board 80 without a slant or oblique angle. The electronic product 70 contacts the chip of the circuit board 80 tightly to increase heat dissipation efficiency.

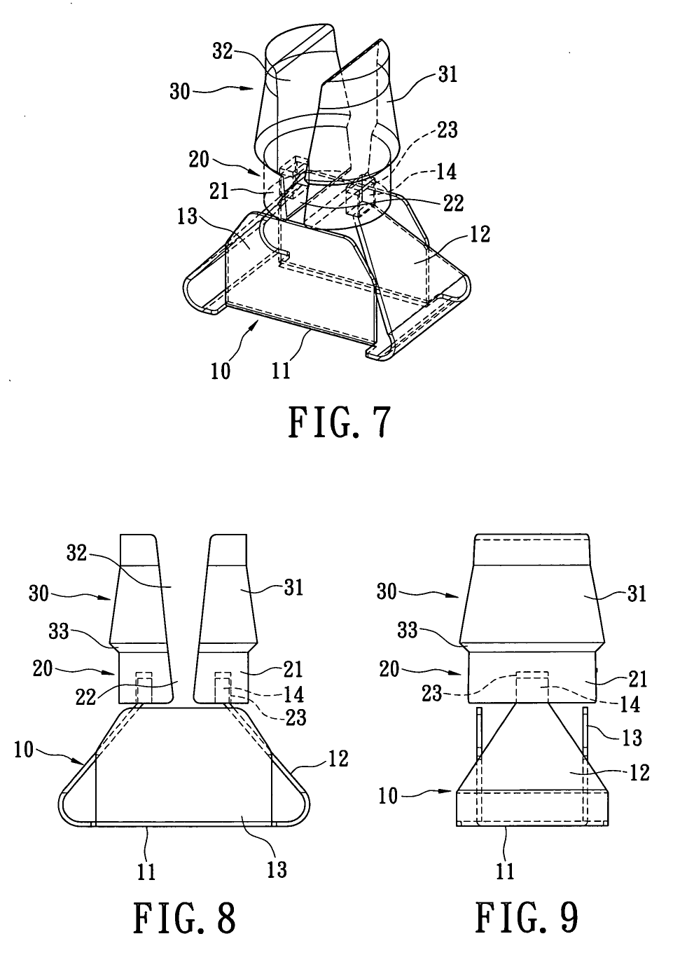

With respect to FIGS. 7 to 9, the embodiment of the present invention is detachable. The base 10 is punched and made of resilient metallic materials, the neck portion 20 and the guide-in portion 30 separate from the base 10, and the neck portion 20 and the guide-in portion 30 are made of resilient materials, such as rubbers or plastics. Each side plate 12 of the base 10 has an insertion member 14 disposed on an upper end thereof, and the neck portion 20 has an insertion hole 23 formed in a lower end thereof to correspond to the insertion member 14 for the neck portion 20 and the guide-in portion 30 to be inserted into the base 10.

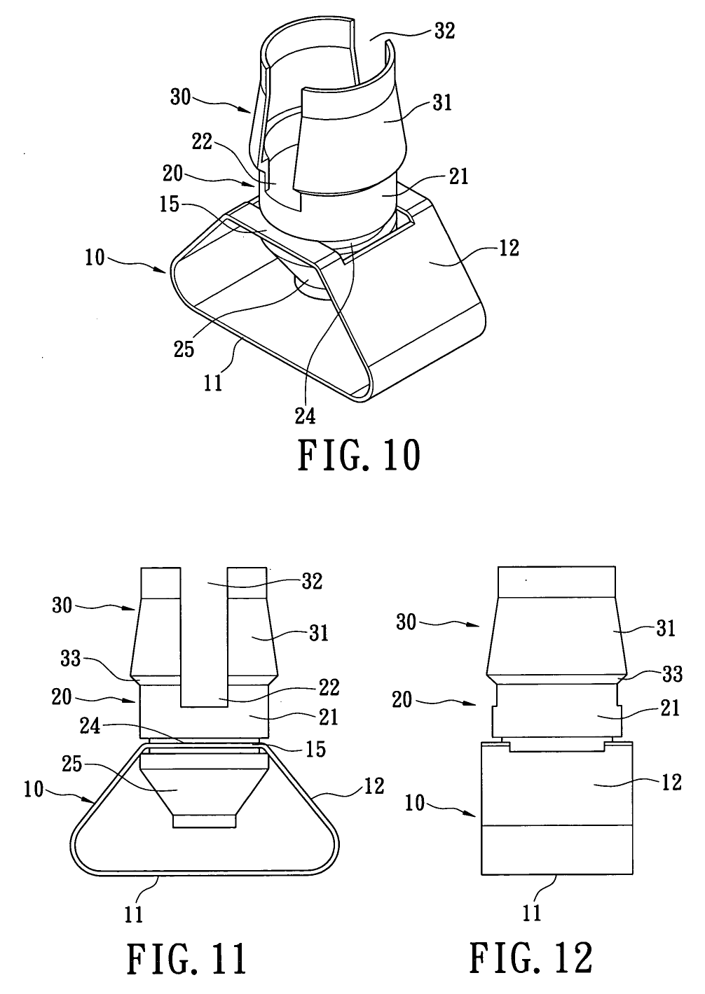

With respect to FIGS. 10 to 12, the embodiment of the present invention is also detachable. The base 10 is punched and made of resilient metallic materials, the neck portion 20 and the guide-in portion 30 separate from the base 10, and the neck portion 20 and the guide-in portion 30 are made of plastic materials or metallic materials. Each side plate 12 of the base 10 has an engaging member 15 disposed on an upper end thereof, and the neck portion 20 has an engaging slot 24 formed in an exterior surface thereof to correspond to the engaging member 15 for the neck portion 20 and the guide-in portion 30 to assemble into the base 10. The neck portion 20 has a height-retention post 25 extending downwardly from a bottom thereof; when the base 10 supports the neck potion 20, the height-retention post 25 is retained against a bottom of the neck portion 20 to avoid the base 10 over-deforming.

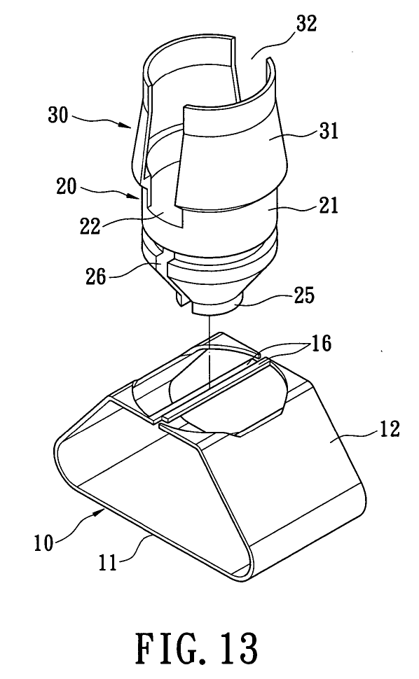

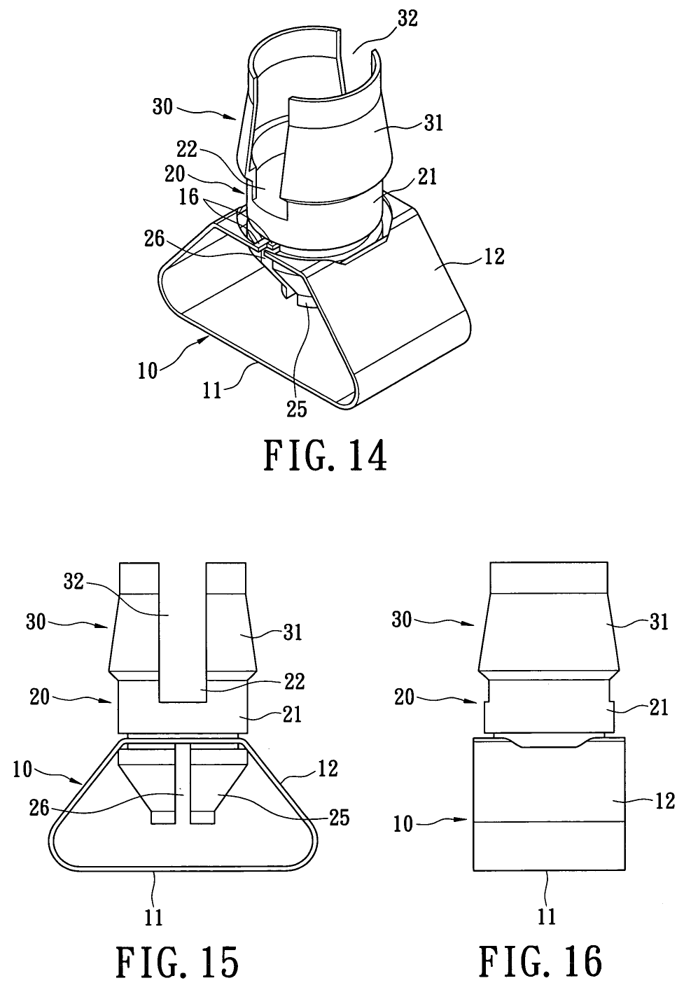

FIGS. 13 to 16 represents a detachable-type secure device. The base 10 is punched and made of resilient metallic materials, the neck portion 20 and the guide-in portion 30 separate from the base 10, and the neck portion 20 and the guide-in portion 30 are made of plastic materials or metallic materials. Each side plate 12 of the base 10 has an embedding member 16 disposed on an upper end thereof, and the neck portion 20 has an embedding slot 26 formed therein to correspond to the embedding member 16 for the neck portion 20 and the guide-in portion 30 to be inlayed into the base 10.

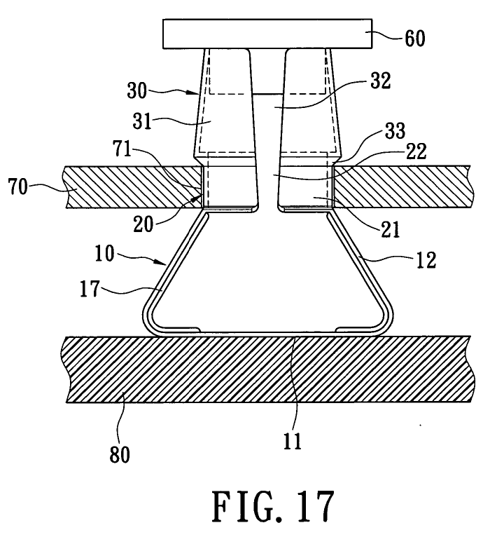

FIG. 17 represents the secure device providing ribs 17 punched and extending downwardly to the orientation plate 12. When the base 10 loads, the ribs 17 provide strengthened intension to avoid the base 10 over-deforming. In this embodiment, the height-retention wall 13 can be replaced and omitted thereby.

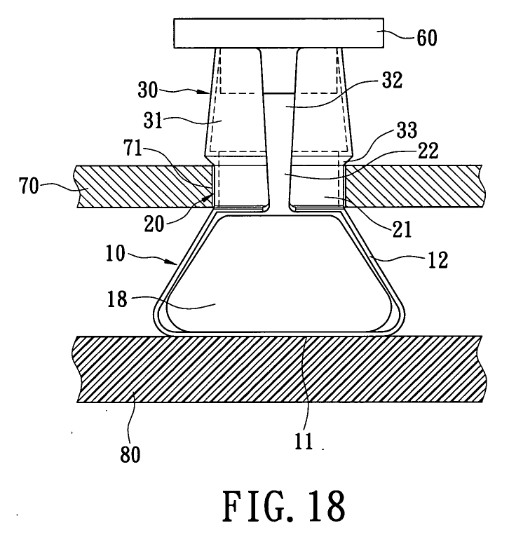

Referring to FIG. 18, the orientation plate 11 of the base 10 has a height-retention post 18 disposed thereon; the height-retention post 18 is made of resilient materials, such as, for example, metal, plastic or rubber. When the base 10 loads, the height-retention post 18 is retained against a bottom of the neck portion 20 to avoid the base 10 over-deforming.

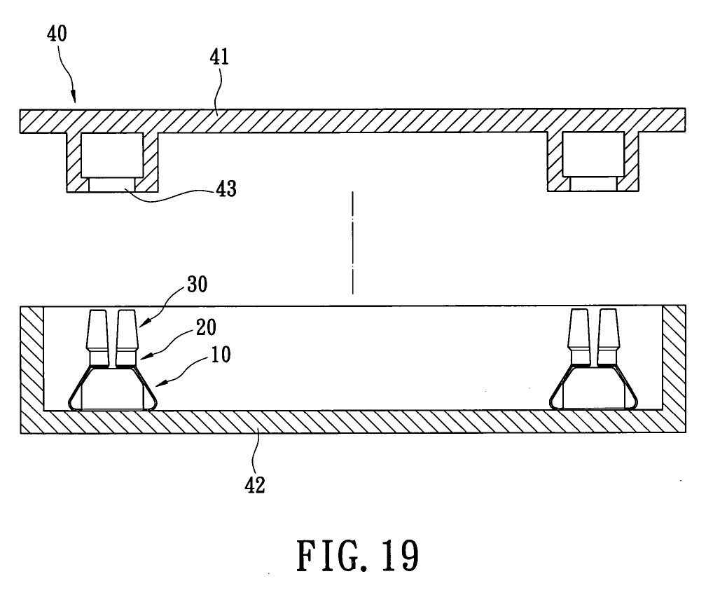

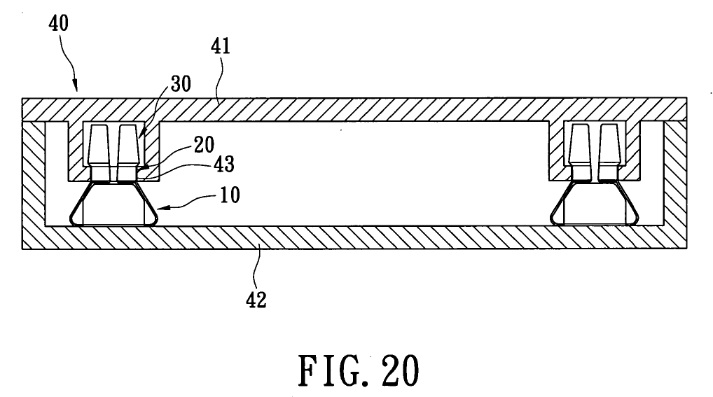

Illustrated in FIG. 19 and 20, the secure device connects two objects together, such as a housing 40 having an upper casing 41 and a lower casing 42 connecting with each other via the secure device. The upper casing 41 and the lower casing 42 are made of metallic materials or plastic materials, the present invention provides a plurality of secure devices disposed on one object (the lower casing 42), the orientation plate 11 of the base 10 connects the object (the lower casing 42) by soldering or the like, and the other object (upper casing 41) has a clamping portion 43 corresponding to the secure device. The guide-in portion of the secure device guides the clamping portion of the other object (upper casing 41) for the clamping portion 43 to engage with the neck portion 20 of the secure device. The two objects (the upper casing 41 and the lower casing 42) can be combined to be the housing 40.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A secure device comprising:
a base having an orientation plate and two side plates respectively connecting two lateral sides of the orientation plate;
a neck portion having two first half bodies and a first cut slot formed between the two half bodies, the two first half bodies including first lower ends thereof connecting the base; and
a guiding-in portion having two second half bodies and a second cut slot formed therebetween, the two second half bodies including second lower ends thereof connecting the neck portion, and the second cut slot communicating with the first cut slot of the neck portion, wherein the guiding-in portion includes a lower exterior diameter longer than an upper exterior diameter of the neck portion for the neck portion to be comparatively shrunk with the guiding-in portion.

2. The secure device as claimed in claim 1, wherein the two side plates of the base are slanted toward each other, or are resilient.

3. The secure device as claimed in claim 1, wherein the orientation plate of the base has a height-retention wall or a height-retention post.

4. The secure device as claimed in claim 1, wherein the two side plates of the base respectively include ribs extending downwardly to the orientation plate.

5. The secure device as claimed in claim 1, wherein the first half bodies of the neck portion are hollow, half-cylindrical and relative to each other.

6. The secure device as claimed in claim 1, wherein the neck portion has a height-retention post extending from a lower portion thereof.

7. The secure device as claimed in claim 1, wherein the two second half-bodies of the guide-in portion are hollow, half-conical and relative to each other.

8. The secure device as claimed in claim 1, further including an inclined face formed between the neck portion and the guide-in portion.

9. The secure device as claimed in claim 1, wherein the neck portion and the guide-in portion separate from the base, each side plate of the base has an insertion member disposed on an upper end thereof, and the neck portion has an insertion hole formed in a lower end thereof to correspond to the insertion member for the neck portion and the guide-in portion inserted into the base.

10. The secure device as claimed in claim 1, wherein the neck portion and the guide-in portion separate from the base, each side plate of the base has an engaging member disposed on an upper end thereof, and the neck portion has an engaging slot formed in an exterior surface thereof to correspond to the engaging member for the neck portion and the guide-in portion assembling into the base.

11. The secure device as claimed in claim 1, wherein the neck portion and the guide-in portion separate from the base, each side plate of the base has an embedding member disposed on an upper end thereof, and the neck portion has an embedding slot formed therein to correspond to the embedding member for the neck portion and the guide-in portion to be inlaid into the base.
